(19) United States
(12) Patent Application Publication
(10) Pub. No.: US 2013/0180107 A1
(43) Pub. Date: Jul. 18, 2013

(54) METHOD FOR REFURBISHING A TURBO-MACHINE COMPONENT

(71) Applicants: Steven Charles Woods, Easley, SC (US); John David Ward, JR., Woodruff, SC (US); Antonio Rodriguez, Simpsonville, SC (US)

(72) Inventors: Steven Charles Woods, Easley, SC (US); John David Ward, JR., Woodruff, SC (US); Antonio Rodriguez, Simpsonville, SC (US)

(21) Appl. No.: 13/350,782

(22) Filed: Jan. 15, 2012

(51) Int. Cl. B23P 6/00

(52) U.S. Cl. 29/889.1

(57) ABSTRACT

A method for preparing to refurbish a turbo-machine component includes virtually refurbishing the turbo-machine component, actually refurbishing the turbo-machine component, and comparing the virtually refurbished turbo-machine component to the actually refurbished turbo-machine component.

### FIELD OF THE INVENTION

The present invention generally involves a method for refurbishing a turbo-machine component.

### BACKGROUND OF THE INVENTION

Turbo-machines are widely used in industrial and commercial operations. For example, a typical commercial gas turbine used to generate electrical power includes a compressor at the front, one or more combustors around the middle, and a turbine at the rear. The compressor generally includes alternating stages of stator vanes and rotating blades as is known in the art. Ambient air enters the compressor as a working fluid, and the compressor progressively imparts kinetic energy to the working fluid to produce a compressed working fluid at a highly energized state. The compressed working fluid exits the compressor and flows to the combustors where it mixes with fuel and ignites to generate combustion gases having a high temperature and pressure. The turbine generally includes alternating stages of stator vanes and rotating blades. The stator vanes may be attached to a stationary component such as a casing that surrounds the turbine, and the rotating blades may be attached to a rotor located along an axial centerline of the turbine. The combustion gases flow through the turbine where they expand to produce work.

Over time, various components in the turbo-machine continuously subjected to high temperatures and/or fluid flow may bend, corrode, and/or plastically deform as a result of creep, oxidation, and/or foreign object debris flowing through the turbo-machine. As a result, components are periodically removed and inspected to determine if the shape, dimensions, and/or defects make the components no longer serviceable. If serviceable, the component may be refurbished, for example, to restore a desired wall thickness or coating and/or to remove undesirable pitting, striations, or other wear-related defects in the surface of the component.

When the refurbishment is complete, it is desirable to verify that the refurbishment did not unintentionally alter the geometry of the component. For example, the component may be compared to the original design guidelines for the component. However, the original design guidelines for the component generally will not take into account the creep or other plastic deformation that existed in the previously acceptable component prior to the refurbishment. As a result, a comparison of the refurbished component with the original design guidelines may result in unnecessary rejections of refurbished components and/or unnecessary re-work of the refurbished components. Therefore, an improved method for refurbishing a turbo-machine component that takes into account the creep or other plastic deformation that existed in the previously acceptable component prior to refurbishment would be useful.

### BRIEF DESCRIPTION OF THE INVENTION

Aspects and advantages of the invention are set forth below in the following description, or may be obvious from the description, or may be learned through practice of the invention.

One embodiment of the present invention is a method for preparing to refurbish a turbo-machine component. The method includes virtually refurbishing the turbo-machine component, creating a three-dimensional image of the virtually refurbished turbo-machine component, and actually refurbishing the turbo-machine component. The method further includes creating a three-dimensional image of the actually refurbished turbo-machine component and comparing the three-dimensional image of the virtually refurbished turbo-machine component to the three-dimensional image of the actually refurbished turbo-machine component.

Another embodiment of the present invention is a method for preparing to refurbish a turbo-machine component that includes creating a first three-dimensional image of the turbo-machine component and replicating a smooth and continuous surface in at least one of the turbo-machine component or the first three-dimensional image of the turbo-machine component. The method further includes creating a second three-dimensional image of the replicated smooth and continuous surface in at least one of the turbo-machine component or the first three-dimensional image of the turbo-machine component, actually refurbishing the turbo-machine component, and creating a third three-dimensional image of the actually refurbished turbo-machine component. In addition, the method includes comparing the second three-dimensional image to the third three-dimensional image.

The present invention may also include a method for preparing to refurbish a turbo-machine component that includes virtually refurbishing the turbo-machine component, actually refurbishing the turbo-machine component, and comparing the virtually refurbished turbo-machine component to the actually refurbished turbo-machine component.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a flow diagram of a method for refurbishing a turbo-machine component according to one embodiment of the present invention;

FIG. 2 is a perspective view of the suction and pressure sides of an exemplary airfoil prior to refurbishment;

FIG. 3 is a perspective view of the suction and pressure sides of the exemplary airfoil shown in FIG. 2 after virtual refurbishment;

FIG. 4 is a perspective view of the suction and pressure sides of the exemplary airfoil shown in FIG. 2 after actual refurbishment; and

FIG. 5 is a perspective view of the suction and pressure sides of the actually refurbished airfoil shown in FIG. 4 compared to the virtually refurbished airfoil shown in FIG. 3.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a method for preparing to refurbish a turbo-machine component. In general, the method “virtually refurbishes” the component, using any of several possible techniques to simulate the shape and dimensions of the component after refurbishment. The method then actually refurbishes the component, using any of several possible techniques to actually restore surfaces and/or remove undesirable pitting, striations, or other wear-related defects in the surface of the component. Lastly, the method compares the actually refurbished component to the virtually refurbished component to determine the accuracy, effectiveness, and/or acceptance of the actual refurbishment. Although exemplary embodiments of the present invention will be described generally in the context of an airfoil included in a gas turbine for purposes of illustration, one of ordinary skill in the art will readily appreciate that embodiments of the present invention may be applied to any component included in a gas turbine or other turbo-machine unless specifically recited in the claims.

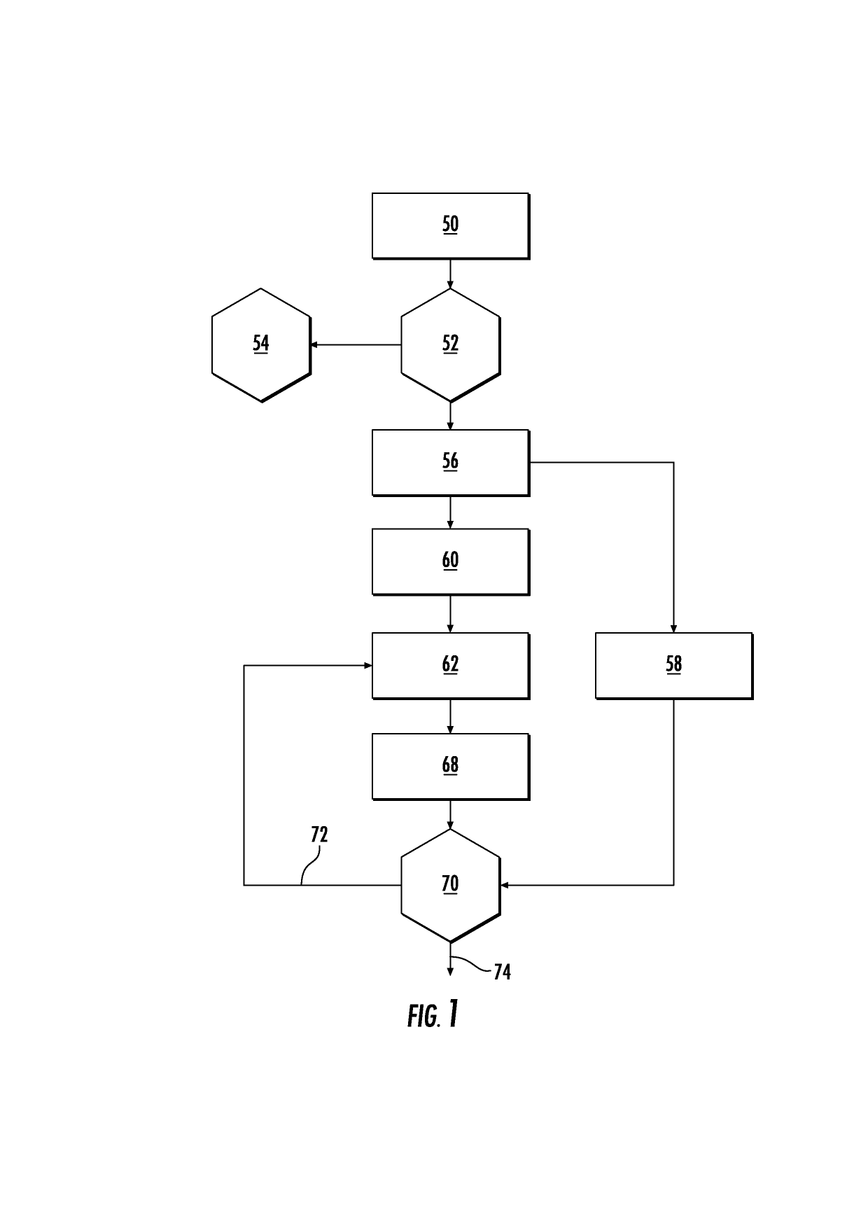

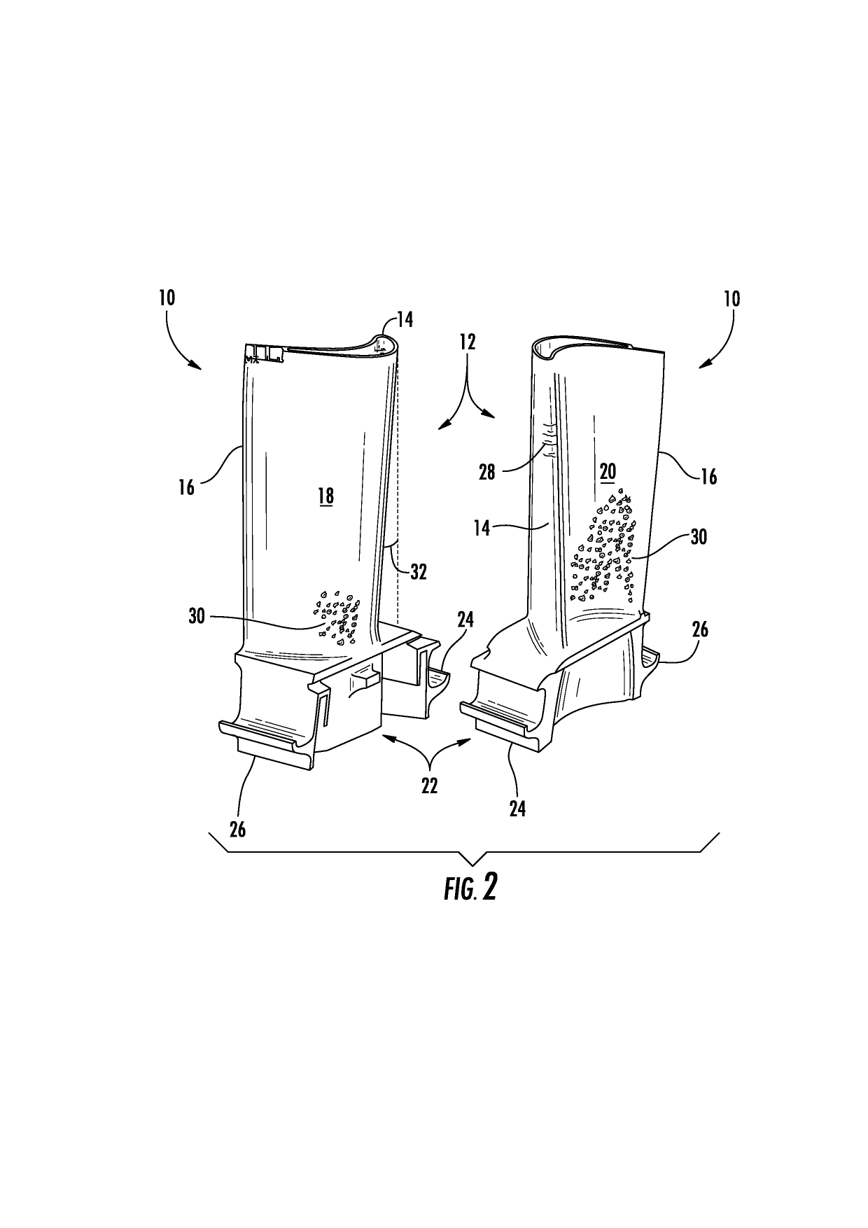

FIG. 1 provides a flow diagram of various steps that may be included in the method for refurbishing a turbo-machine component 10 according to one embodiment of the present invention, and FIGS. 2-5 illustrate conditions of an exemplary airfoil 12 during various stages of the refurbishment. As shown in FIGS. 2-5, the exemplary airfoil 12 may generally include a leading edge 14, a trailing edge 16, a suction side 18, and a pressure side 20. In addition, the airfoil 12 may be connected to a platform 22 having leading and trailing surfaces 24, 26. Any portion of the airfoil 12 and/or platform 22 may experience bending, corrosion, and/or other form of plastic deformation that may be refurbished using various embodiments of the present invention.

Beginning with block 50 in FIG. 1, the method may include initial receipt, cleaning, and/or inspection of the component 10. The initial cleaning of the component 10 may include, for example, various methods to remove any loose corrosion or other debris adhering to the component 10 that might obscure or otherwise influence the initial inspection of the component 10. By way of non-limiting example, acid washing, pressure washing, sanding, or other blending methods may be used to initially clean the component 10. The initial inspection of the component 10 may include visual inspections, gross measurements, and/or detailed measurements of the component 10 to provide an initial assessment regarding whether the component 10 is capable of or suitable for refurbishment. For example, in the case of the exemplary airfoil 12 shown in FIGS. 2-6, the leading and trailing surfaces 24, 26 of the platform 22 may be inspected and/or measured to determine, for example, if the platform 22 has been damaged or otherwise distorted beyond what could be corrected through refurbishment. Alternatively or in addition, the airfoil 12 may be ultrasonically inspected and/or measured to determine, for example, the wall thickness, pitting depth, crack size, and/or curvature of the various surfaces of the airfoil 12.

At step 52, the initial observations and/or measurements may be compared to existing guidelines or predetermined limits to determine if the component 10 may be refurbished without requiring replacement. For example, the measured wall thickness, pitting, depth, crack size, and/or curvature of the airfoil 12 may be compared to a predetermined limit, and if the measured feature is less than the predetermined limit, then the airfoil 12 will be scrapped and replaced, as represented by block 54 in FIG. 1. Alternatively, the method may continue with virtually refurbishing the component 10, indicated by blocks 56 and 58 in FIG. 1.

At block 56, the component 10 may again be cleaned, or initially cleaned if not cleaned before, to prepare the component 10 for scanning or other processing to create a three-dimensional image of the component 10 prior to any refurbishment or repairs to the component 10. The outer surface of the component 10 may be scanned to create a three dimensional point cloud that may be converted into a contoured surface to create the three-dimensional image of the component 10 before any refurbishment or repairs. By way of non-limiting example, a white light, blue light, laser, or other scanner capable of creating an image of the outer surface of the component 10 may be used to create the three-dimensional image of the component 10 prior to refurbishment. Since the component 10 has not yet been refurbished, the three-dimensional image will include or reflect the defects, pitting, cracks, or other blemishes in the outer surface of the component 10 to be corrected during the refurbishment. In addition, the three-dimensional image of the component 10 will include any creep or other plastic deformation that existed in the previously acceptable component 10 that will generally not be changed or altered during the upcoming refurbishment of the component 10.

FIG. 2 provides perspective views of the suction and pressure sides 18, 20 of the exemplary airfoil 12 prior to refurbishment. As shown, the exemplary airfoil 12 may include striations 28 or cracks in the leading edge 14 and/or pitting 30 or other corrosive effects in the suction and pressure sides 18, 20 and/or platform 22. In addition, the angle of the airfoil 12 with respect to the platform 22, represented by angle 32 in FIG. 2, may be slightly different from the original design guidelines as a result of creep and other plastic deformation of the airfoil 12 associated with previous operations. One of ordinary skill in the art will readily appreciate that angle 32 is simply a representative example of any variation between the airfoil 12 prior to refurbishment and the originally manufactured airfoil 12 and which the refurbishment is not intended to correct.

At block 58, CAD software or other meshing techniques may be used to interpolate the three-dimensional image of the component 10 to create or simulate the three-dimensional image of the component 10 after the refurbishment, thereby “virtually refurbishing” the component 10. For example, the virtual refurbishment may change the wall thickness over the three-dimensional image of the component 10. Alternatively or in addition, the virtual refurbishment may replicate a smooth and continuous surface in the three-dimensional image of the component 10 to remove defects, pitting, cracks, or other blemishes in the outer surface of the component 10 desired to be accomplished through the actual refurbishment. However, the virtual refurbishment would not otherwise remove or change any of the creep or other plastic deformation present in the three-dimensional image of the previously acceptable component 10 prior to the virtual refurbishment.

As a suitable alternative to the scanning and computer generated virtual refurbishment of the component 10, as previously described with respect to blocks 56 and 58 in FIG. 1, a removable filler material may be applied to the component 10 to simulate or replicate the anticipated refurbishment. For example, plaster, putty, or similar material may be applied to the outer surface of the component 10 to change the thickness of the component 10 and/or produce a smooth and continuous surface in the component 10 that simulates the removal of defects, pitting, cracks, or other blemishes in the outer surface of the component 10 desired to be accomplished through the actual refurbishment. The simulated repaired component 10 may then be scanned as previously described with respect to block 56 to produce the three-dimensional image of the virtually refurbished component 10 described with respect to block 58.

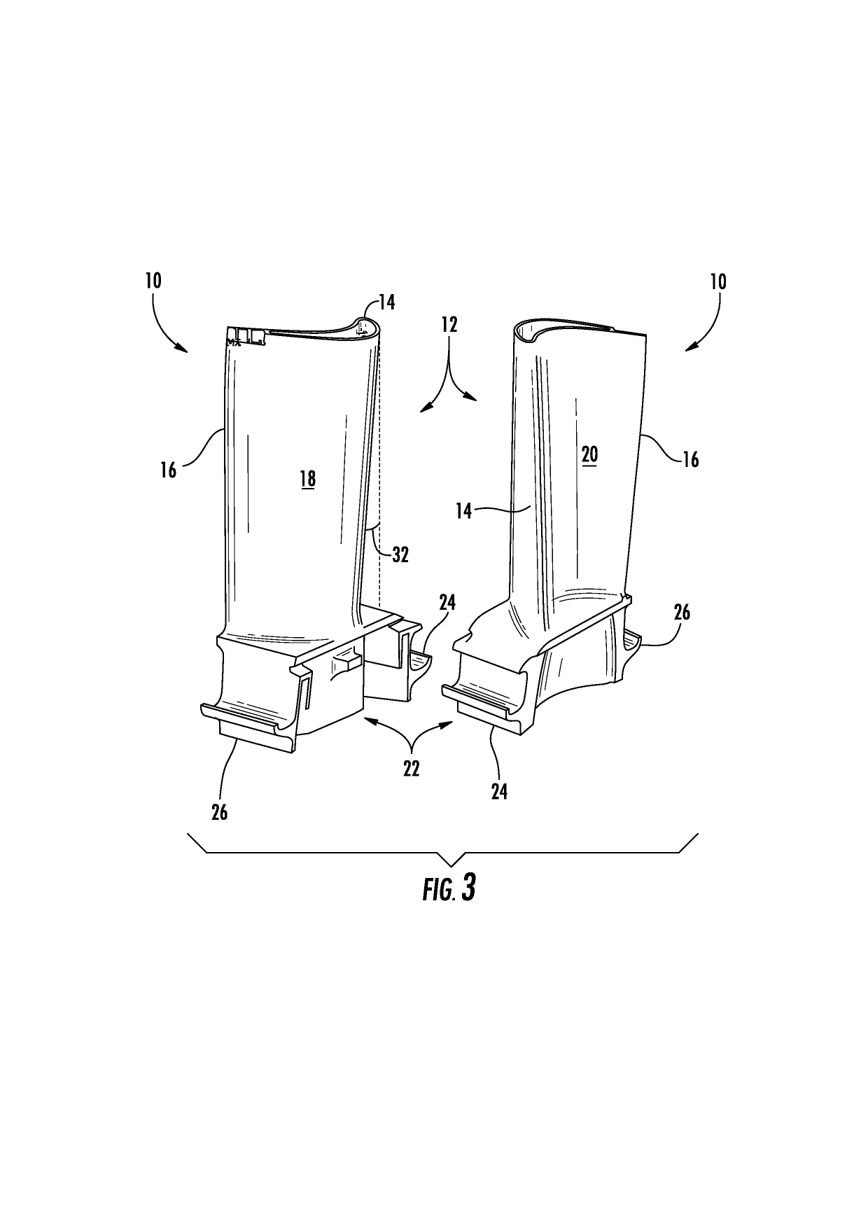

FIG. 3 provides perspective views of the suction and pressure sides 18, 20 of the exemplary airfoil 12 shown in FIG. 2 after virtual refurbishment. As shown in FIG. 3, the virtually refurbished airfoil 12 has a smooth and continuous outer surface, representing the anticipated appearance of the airfoil 12 after the actual refurbishment. However, any creep or other plastic deformation that existed in the previously acceptable airfoil 12 remains substantially unchanged in the virtually refurbished airfoil 12. Specifically, as shown in FIG. 3, the angle 32 of the virtually refurbished airfoil 12 with respect to the platform 22 remains substantially unchanged from the images shown in FIG. 2. This virtually refurbished airfoil 12 may later be used as a standard by which to evaluate the serviceability of the actually repaired airfoil 12.

At block 60, the non-aerodynamic surfaces of the component 10 are actually refurbished, and at block 62, the aerodynamic surfaces of the component 10 are actually refurbished. The actual refurbishment of the non-aerodynamic and aerodynamic surfaces may include multiple, iterative steps involving heat treating, building up, blending, and/or cleaning the outer surface of the component 10. For example, the component 10 may be heat treated prior to welding or brazing to build up the outer surfaces of the component 10. The welded or brazed portions may then be grinded or machined to blend the refurbished areas with the other portions of the component 10. The component 10 may then be cleaned and the process repeated as desired.

At block 68, the refurbished component 10 is again scanned or otherwise imaged to create a three-dimensional image of the actually refurbished component 10. For example, as previously discussed with respect to block 56, the outer surface of the refurbished component 10 may be scanned to create a three dimensional point cloud that may be used to create the three-dimensional image of the refurbished component 10. The three-dimensional image of the refurbished component 10 will reflect the actual refurbishment that removed or otherwise changed the wall thickness, defects, pitting 30, cracks 28, or other blemishes in the outer surface of the component 10. In addition, the three-dimensional image will include any creep or other plastic deformation that existed in the previously acceptable component 10 that generally remains unchanged or unaltered by the actual refurbishment of the component 10.

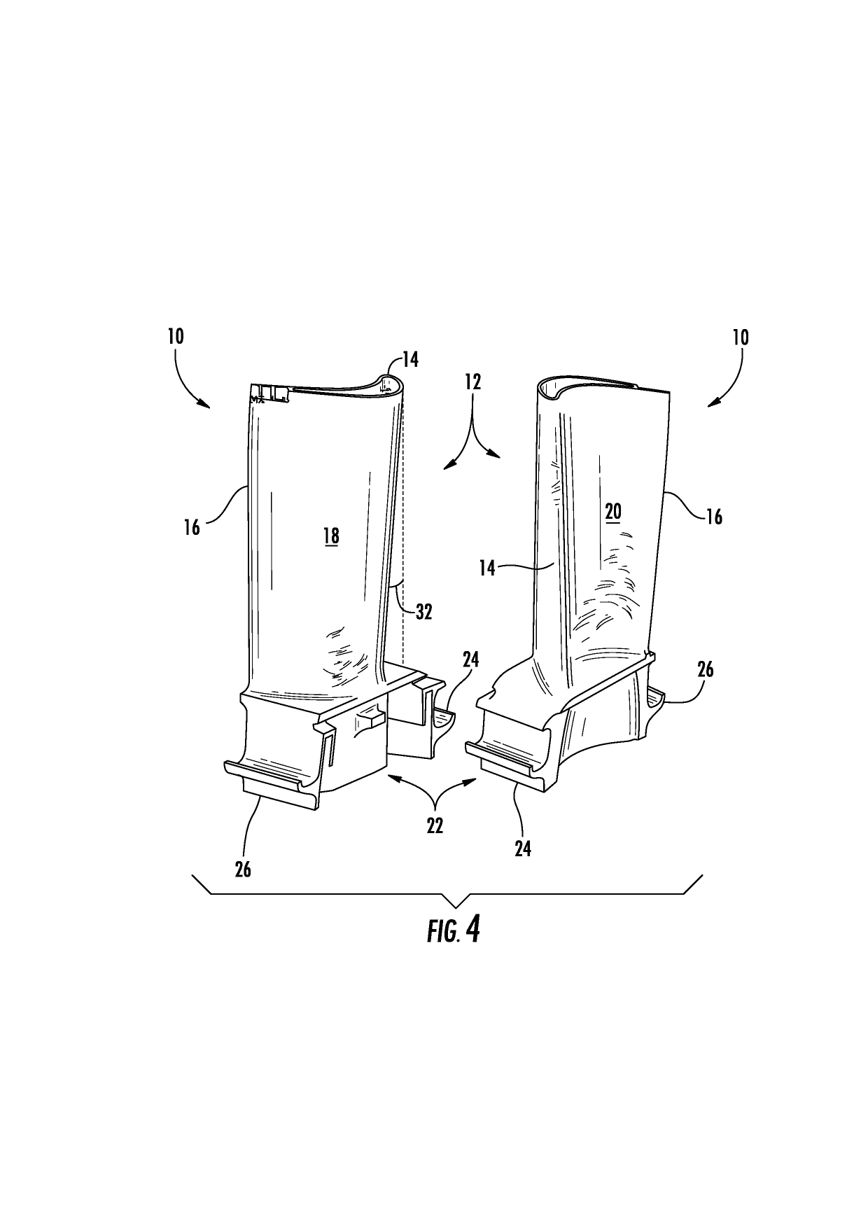

FIG. 4 provides perspective views of the suction and pressure sides 18, 20 of the exemplary airfoil 12 after the actual refurbishment. As shown in FIG. 4, the refurbished airfoil 12 no longer includes the striations 28, pitting 30, or other corrosive effects visible in the airfoil 12 shown in FIG. 2. However, the actual refurbishment was not intended to remove or change any of the creep or other plastic deformation that existed in the previously acceptable airfoil 12. As a result, the angle 32 of the airfoil 12 with respect to the platform 22 remains generally unchanged by the refurbishment.

At block 70, the three-dimensional image of the virtually refurbished component 10, created during step 58, is compared to the three-dimensional image of the actually refurbished component 10, created during step 68. The comparison may be performed manually or using suitable software designed to detect and/or quantify differences between the images of the virtually refurbished and actually refurbished components 10. In this manner, the accuracy, effectiveness, and/or acceptance of the actual refurbishment may be determined, while also taking into account the creep or other plastic deformation that existed in the previously acceptable component 10.

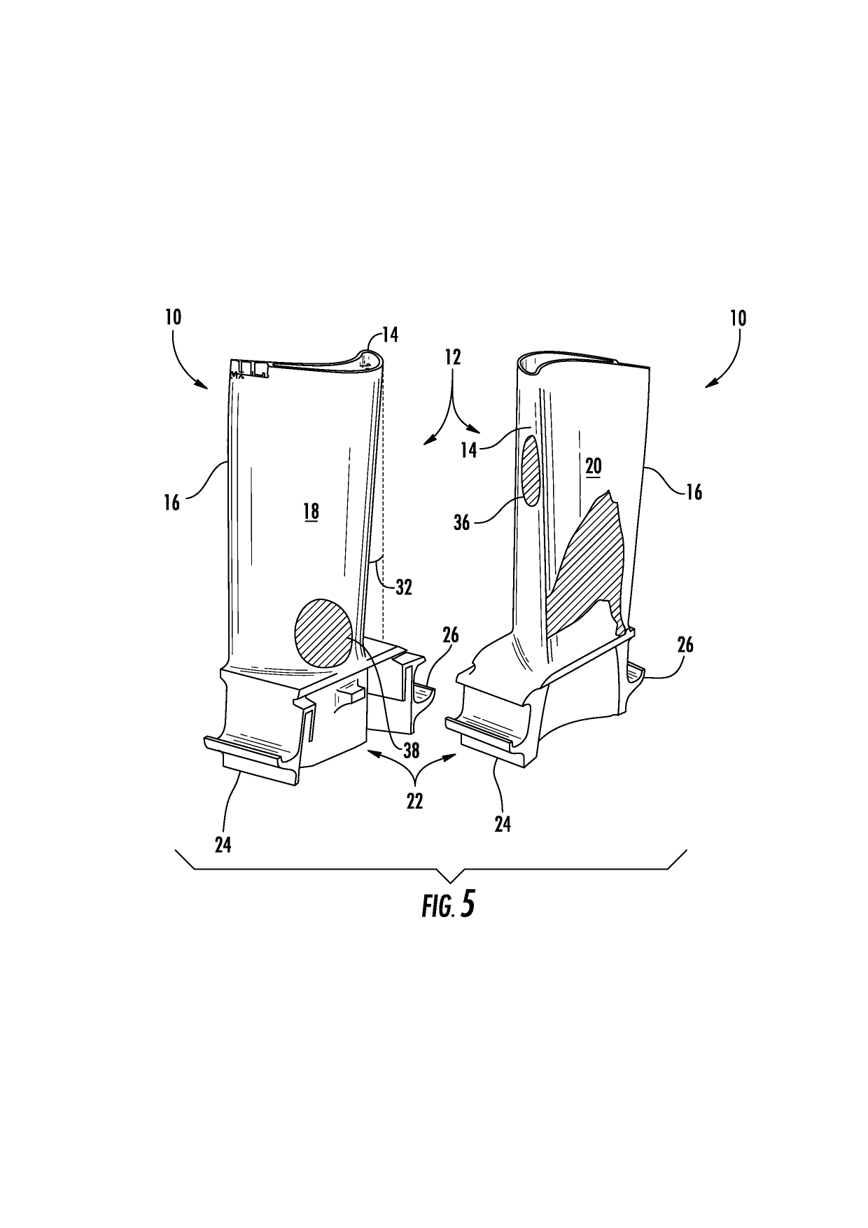

FIG. 5 provides perspective views of the suction and pressure sides 18, 20 of the actually refurbished airfoil 12 shown in FIG. 4 compared to the virtually refurbished airfoil 12 shown in FIG. 3. As shown in FIG. 5, for example, the comparison may identify an area 36 on the leading edge 14 in the vicinity of the previously existing cracks 28 and an area 38 on the suction side 18 of the airfoil 12 in the vicinity of the previously existing pitting 30 as needing additional blending to meet predetermined limits critical to quality. If necessary, the actually refurbished airfoil 12 may receive additional refurbishment, as shown by the flow path 72 in FIG. 1, or the airfoil 12 may be returned to service, as shown by the flow path 74 in FIG. 1.

The various steps shown and described with respect to FIGS. 1-5 provide one or more advantages over existing techniques. For example, the embodiments disclosed herein facilitate creation of virtually refurbished components 10. The virtually refurbished components 10 may later function as geometric standards to be compared to the actually refurbished components 10. Since the virtually refurbished standard includes creep or other plastic deformation that existed in the previously acceptable component, the rejections and/or re-work of the actually refurbished components 10 due to unacceptable geometry will be reduced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for preparing to refurbish a turbo-machine component, comprising:
a. virtually refurbishing the turbo-machine component;
b. creating a three-dimensional image of the virtually refurbished turbo-machine component;
c. actually refurbishing the turbo-machine component;
d. creating a three-dimensional image of the actually refurbished turbo-machine component; and
e. comparing the three-dimensional image of the virtually refurbished turbo-machine component to the three-dimensional image of the actually refurbished turbo-machine component.

2. The method as in claim 1, further comprising comparing a wall thickness of the turbo-machine component to a predetermined limit.

3. The method as in claim 1, wherein the virtually refurbishing step includes cleaning the turbo-machine component.

4. The method as in claim 1, wherein the virtually refurbishing step includes creating a three-dimensional image of the turbo-machine component.

5. The method as in claim 1, wherein the virtually refurbishing step includes replicating a smooth and continuous surface in the turbo-machine component.

6. The method as in claim 1, wherein the actually refurbishing step includes refurbishing an airfoil on the turbo-machine component.

7. The method as in claim 1, wherein the actually refurbishing step includes brazing an airfoil on the turbo-machine component.

8. A method for preparing to refurbish a turbo-machine component, comprising:
a. creating a first three-dimensional image of the turbo-machine component;
b. replicating a smooth and continuous surface in at least one of the turbo-machine component or the first three-dimensional image of the turbo-machine component;
c. creating a second three-dimensional image of the replicated smooth and continuous surface in at least one of the turbo-machine component or the first three-dimensional image of the turbo-machine component;
d. actually refurbishing the turbo-machine component;
e. creating a third three-dimensional image of the actually refurbished turbo-machine component; and
f. comparing the second three-dimensional image to the third three-dimensional image.

9. The method as in claim 8, further comprising comparing a wall thickness of the turbo-machine component to a predetermined limit.

10. The method as in claim 8, further comprising cleaning the turbo-machine component.

11. The method as in claim 8, wherein the step of creating the first three-dimensional image of the turbo-machine component includes scanning an image of the turbo-machine component.

12. The method as in claim 8, wherein the actually refurbishing step includes refurbishing an airfoil on the turbo-machine component.

13. The method as in claim 8, wherein the actually refurbishing step includes brazing an airfoil on the turbo-machine component.

14. A method for preparing to refurbish a turbo-machine component, comprising:
a. virtually refurbishing the turbo-machine component;
b. actually refurbishing the turbo-machine component; and
c. comparing the virtually refurbished turbo-machine component to the actually refurbished turbo-machine component.

15. The method as in claim 14, further comprising comparing a wall thickness of the turbo-machine component to a predetermined limit.

16. The method as in claim 14, wherein the virtually refurbishing step includes creating a three-dimensional image of the turbo-machine component.

17. The method as in claim 14, wherein the virtually refurbishing step includes replicating a smooth and continuous surface in the turbo-machine component.

18. The method as in claim 14, wherein the actually refurbishing step includes refurbishing an airfoil on the turbo-machine component.
